(19) United States
(12) Patent Application Publication
(10) Pub. No.: US 2004/0108734 A1
(43) Pub. Date: Jun. 10, 2004

(54) DOOR LOCKING MECHANISM

(76) Inventors: Alan James Maple, Chesire (GB); Ian Martin Lennard, Chesire (GB)

Correspondence Address: MCGARRY BAIR PC, 171 MONROE AVENUE, N.W., SUITE 600, GRAND RAPIDS, MI, 49503, US

(21) Appl. No.: 10/604,575

(22) Filed: Jul. 31, 2003

(30) Foreign Application Priority Data
Aug. 2, 2002 (GB) GB 02 17984.4

(51) Int. Cl. E05C 7/00

(52) U.S. Cl. 292/177; 292/38

(57) ABSTRACT

A locking mechanism for a hinged door comprises first and second actuators having first and second bolts associated therewith, each said bolt being movable between free and locked settings. The first actuator is adapted for mounting on a frame for the hinged door, and the second actuator is adapted for mounting on the door at a location spaced from the first actuator. A drive mechanism interconnects the second actuator with the first bolt when in its locked setting, such that operation of the first actuator to move the first bolt to its locked setting causes operation of the second actuator to move the second bolt to its locked setting.

### CROSS REFERENCE TO RELATED APPLICATIONS

This application claims priority from British Patent Application No. 02 17984.4 filed on Aug. 2, 2002.

### BACKGROUND OF INVENTION

1. Field of the Invention

This invention relates to a hinged-door locking mechanism and in particular but not exclusively to a locking mechanism suitable for use on a commercial vehicle or cargo container having at least one access door hinged about a vertical edge to a frame within which the door fits.

2. Description of the Related Art

Many box-body commercial vehicles and cargo containers are provided with a pair of so-called barn doors at the rear end, which doors are hinged to vertical side frame members of the vehicle body or container, such that the doors may be hinged outwardly to lie back against the side of the body or container, to give free access to the interior of the body or container. Usually, one door must be closed first and then closing of the second door holds the one door closed, such that a suitable closure and locking mechanism for the second door is sufficient to maintain both doors closed and locked.

Various locking mechanisms have been designed for box-body commercial vehicles and cargo containers having barn doors. For enhanced security, it is advantageous to provide mechanisms which lock to both upper and lower frame members around the opening for the doors. If both such mechanisms are key-operated or otherwise power-operated, either a complex mechanism must be provided within the structure of the door, or suitable mechanisms are required both above and below the second door, to permit locking to be performed. In the case of the former, power cables or conduits must be arranged for communication with the inside face of the door but these are prone to wear or other deterioration as the doors are opened and closed. In the case of the latter, there can be problems ensuring synchronized operation of both mechanisms especially if the opening exposed by the doors is not to be obstructed.

### SUMMARY OF INVENTION

A principal aim of the present invention is to provide a mechanism suitable for use for example on a commercial vehicle body and which is of simple construction and yet permits a door to be held closed and locked at two spaced locations (typically, along upper and lower frame members) without requiring power feeds of any kind to be supplied to the inside face of the door.

According to one aspect of the present invention there is provided a locking mechanism for a hinged-door, comprising:

a first actuator including a first bolt movable between free and locked settings, said first actuator being adapted for mounting on a frame for a hinged door and arranged such that said first bolt when in its locked setting, secures the door to the frame to resist opening movement thereof;

a second actuator including a second bolt movable between free and locked settings, said second actuator being adapted for mounting on said door at a location spaced from the first actuator, and arranged such that said second bolt, when in its locked setting, also secures the door to the frame to resist opening movement thereof; and

drive means interconnecting the second actuator with the first bolt when in its locked setting, said drive means being adapted for mounting on the door, and arranged such that operation of the first actuator to move the first bolt to its locked setting causes operation of the second actuator to move the second bolt to its locked setting.

According to another aspect of the present invention there is provided a locking mechanism as described above, in combination with a door hingedly mounted for opening movement within a frame, the first actuator being mounted on the frame for co-operation with a receptor for the first bolt mounted on the door and the second actuator also being mounted on the door for co-operation with a keep provided on the frame.

### BRIEF DESCRIPTION OF DRAWINGS

A specific embodiment of this invention is described hereinafter in detail, by way of example only, reference being made to the accompanying drawings in which:

FIG. 1 diagrammatically illustrates a commercial vehicle having barn doors of the kind to which this invention may be applied.

FIG. 2 is a diagrammatic view of the door frame for a pair of barn doors, one of which is provided with the embodiment of locking mechanism.

FIGS. 2A and 2B are detailed views on an enlarged scale of the components shown in the marked areas on FIG. 2.

FIG. 3 illustrates a compression-resistant flexible cable also shown in FIG. 2.

### DETAILED DESCRIPTION

It will be appreciated that with the arrangement of this invention, an actuator may be provided on a fixed frame member at one location around the periphery of the door and which serves to secure the door in its closed position. The drive means transfers the mechanical locking action at that location to a second spaced location such that a further actuator may also secure the door in its closed position at that second location. Typically, the door may in this way be locked along its top and bottom edges, remote from the hinged edge of the door and preferably close to the other vertical edge of the door. Provided that the door configuration is such that one door must be closed before the door which is associated with the locking mechanism then the one door will also be held securely closed when the other door is closed and locked.

Preferably, the drive means includes a plunger mounted for sliding movement within a receptor (or keep) for the first bolt, which receptor is attached to or forms a part of the door. In such a case, the second actuator may comprise a housing also mounted on the door and with the second bolt slidably carried in that housing.

The drive means may include a cable interconnecting the plunger and the second bolt. Such a cable may comprise an outer sheath within which a flexible compression-resistant inner shaft may slide, whereby movement of the plunger can be transferred to the second bolt. Alternatively, the cable could comprise a flexible tensile member suitably arranged to pull the second bolt upon movement of the plunger. A further alternative would be to provide a pneumatic link between the plunger and the second bolt, such a link including for instance a flexible tube transferring pressure generated by the plunger to the second bolt to effect movement thereof.

Yet another possibility would be to use a direct mechanical link such as a rod or other compressive or tensile member to transfer motion from the first bolt to the second actuator.

In an alternative arrangement, the drive means could be electrically-operated, the plunger serving to operate a switch to permit the supply of electricity to the second actuator, to cause the operation thereof. However, such an arrangement would require an electricity feed to the door and this would have the disadvantage of increasing the complexity and the possibility of a supply failure, on account of the flexing of the electricity feed upon opening and closing of the door.

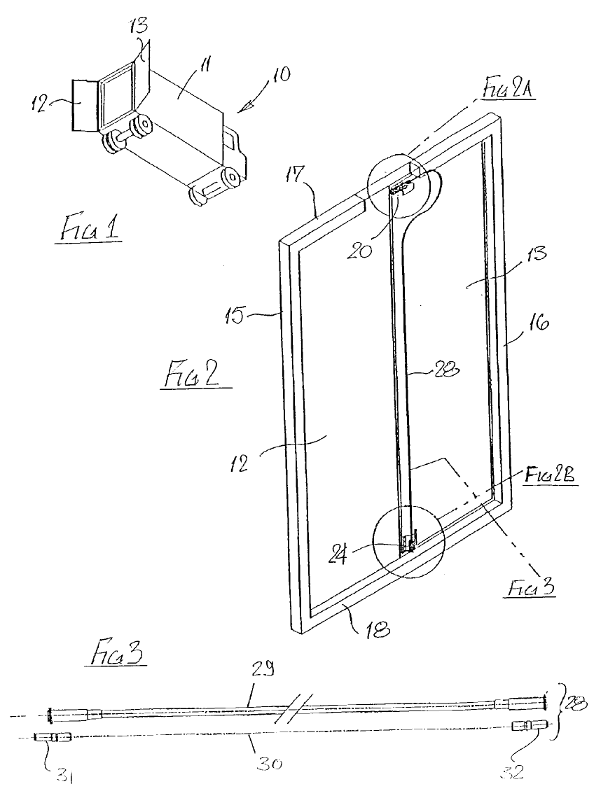

A preferred embodiment of the invention will now be further described with reference to the accompanying FIGS. 1 to 3.

Referring initially to FIG. 1, there is shown diagrammatically a commercial vehicle 10 having a box body 11 provided with a pair of so-called barn doors 12 and 13 at the rear end of the body. Each leaf is hinged to a vertical side edge of the vehicle body and the doors are arranged so that one leaf must be closed first, whereafter closing and securing in the closed position the other leaf holds the one leaf closed.

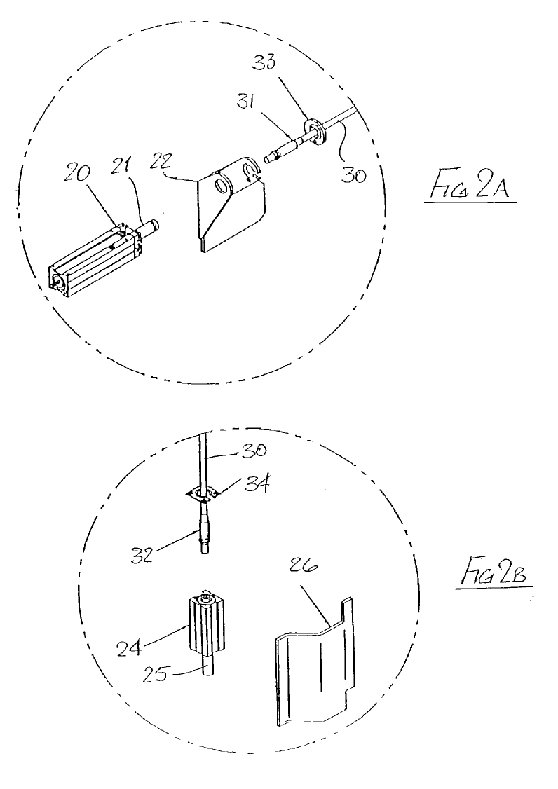

FIG. 2 shows the door arrangement of the vehicle of FIG. 1. At the rear of the body, there is a rectangular frame made up of a pair of vertical members 15 and 16 and upper and lower horizontal members 17 and 18. For a typical vehicle body those members will be of steel box sections, welded together. The doors 12 and 13 are entirely conventional and are hinged to the vertical members 15 and 16, the arrangement being such that door 12 must be closed first and then the closing of door 13 holds door 12 closed.

The upper horizontal member 17 supports a linear actuator 20 having a bolt 21, the line of movement of the bolt being parallel to the horizontal member 17. A receptor (or keep) 22 is secured to the inside face of door 13 immediately adjacent the actuator 20 such that when bolt 21 is withdrawn into the actuator, the door may be closed but subsequent operation of the actuator drives the bolt forwardly out of the housing towards vertical member 15, so that the bolt is received in the receptor and thus restrains opening movement of the door. The actuator may be electrically, pneumatically or hydraulically operated, using fixed power lines secured within the vehicle body.

A second linear actuator 24 is provided on the inside face of door 13, above the lower horizontal member 19 and adjacent the free edge of the door. This actuator includes a bolt 25 which may be received in a suitable opening (or keep) provided in the lower horizontal member, and when so received, also secures the door against opening. A spring (not shown) is provided within the actuator, to maintain the bolt in its withdrawn position, unless driven forwardly against the action of the spring. The actuator 24 is carried on a mounting plate 26 which is itself secured to the door, the plate additionally serving to protect the actuator from accidental damage.

A flexible cable 28 interconnects the receptor 22 associated with the actuator 20 and the bolt 25 of the second actuator 24. This cable comprises an outer sheath 29 within which is slidably mounted a flexible inner shaft 30 adapted to withstand compressive forces. One end of the outer sheath 29 is secured to the receptor 22 and the other end to the second actuator 24. One end of the inner shaft 30 is provided with a plunger 31 which is, when the cable is secured to the receptor 22, directly opposed to and coaxial with the bolt 21, whereas the other end of the shaft is provided with a piston 32, directly opposed to and coaxial with bolt 25. The cable 28 is held to the receptor 22 by a locking plate 33, and to the second actuator 24 by a further locking plate 34.

In use, once the doors 12,13 have been closed, a remote control (typically fitted in the driver's cab) is operated to cause bolt 21 associated with the linear actuator 20 to be projected out of the actuator into receptor 22. This locks the upper edge of the door to the upper member, and also drives plunger 30 into the outer sheath. In turn, through the shaft 30, this drives piston 32 and so causes bolt 25 to be projected into the aperture in the lower horizontal frame member 18. In this way, the door is held securely locked, until the remote control is once more operated to release the locking mechanism.

1. A locking mechanism for a hinged-door comprising:
a first actuator including a first bolt movable between free and locked settings, said first actuator being adapted for mounting on a frame for a hinged door, and arranged such that said first bolt when in its locked setting, secures the door to the frame to resist opening movement thereof;
a second actuator including a second bolt movable between free and locked settings, said second actuator being adapted for mounting on said door at a location spaced from the first actuator and arranged such that said second bolt, when in its locked setting, also secures the door to the frame to resist opening movement thereof; and
drive means interconnecting the second actuator with the first bolt when in its locked setting, said drive means being adapted for mounting on the door and arranged such that operation of the first actuator to move the first bolt to its locked setting causes operation of the second actuator to move the second bolt to its locked setting.

2. A locking mechanism as claimed in claim 1, wherein the drive means includes a receptor for the first bolt, and a plunger mounted for sliding movement within said receptor, said receptor being adapted for mounting on a door.

3. A locking mechanism as claimed in claim 2, wherein the second actuator comprises a housing adapted for mounting on the door, the second bolt being slidably mounted in the housing.

4. A locking mechanism as claimed in claim 2, wherein a spring is provided to urge the second bolt towards its free setting, said second bolt being moveable towards its locked setting against the action of the spring.

5. A locking mechanism as claimed in claim 2 wherein the drive means includes a cable interconnecting the plunger and the second bolt.

6. A locking mechanism as claimed in claim 5, wherein said cable comprises an outer sheath and a flexible compression-resistant inner shaft slidably mounted therewithin, to transfer movement of the plunger to the second bolt.

7. A locking mechanism as claimed in claim 6, wherein the plunger is directly provided on one end of the inner shaft.

8. A locking mechanism as claimed in claim 2 wherein the drive means includes one of a pneumatic link and a hydraulic link, interconnecting the plunger and the second bolt.

9. A locking mechanism as claimed in claim 1, wherein the first actuator is selected from the group consisting of pneumatically, hydraulically and electrically operated actuators.

10. A locking mechanism as claimed in claim 1, in combination with a door hingedly mounted for opening movement within a frame, the first actuator being mounted on the frame for co-operation with a receptor for the first bolt mounted on the door, and the second actuator being mounted on the door for co-operation with a keep provided on the frame

11. A combination as claimed in claim 10, wherein the first actuator is mounted on a frame member extending at right angles to the frame member to which the door is hinged, and the second actuator is mounted on an edge of the door for co-operation with a frame member opposed to that supporting the first actuator.
